(19) United States
(12) Patent Application Publication
(10) Pub. No.: US 2025/0381016 A1
(43) Pub. Date: Dec. 18, 2025

(54) IMPROVED DENTAL MODELS AND OCCLUSION MAPPING

(71) Applicant: ALIGN TECHNOLOGY, INC., San Jose, CA (US)

(72) Inventors: Avi KOPELMAN, Palo Alto, CA (US); Ofer SAPHIER, Rehovot (IL)

(21) Appl. No.: 19/236,655

(22) Filed: Jun. 12, 2025

Related U.S. Application Data
(60) Provisional application No. 63/659,774, filed on Jun. 13, 2024.

(51) Int. Cl. A61C 9/00

(52) U.S. Cl. CPC A61C 9/0053

(57) ABSTRACT

A method may include receiving a 3D model of the patient's upper jaw, receiving a 3D model of the patient's lower jaw, and receiving a model of the patient's upper jaw in occlusion with the patient's lower jaw. The method may also include adjusting a shape of the one or both of the 3D model of the patient's upper jaw and the 3D model of the patient's lower jaw based on the model of the model of the patient's upper jaw in occlusion with the patient's lower jaw and fitting, after adjusting, the 3D model of the patient's upper jaw and the 3D model of the patient's upper jaw. The method may also include generating occlusion map for the patient based on the fitting of the adjusted model of the upper law and the adjusted model of the lower jaw.

### RELATED APPLICATIONS

This application claims the benefit under 35 U.S.C. § 119 (e) of U.S. Provisional Patent Application No. 63/659,774, filed Jun. 13, 2024, and titled “DENTAL MODELS AND OCCLUSION MAPPING,” which is incorporated, in its entirety, by this reference.

### BACKGROUND

Creating a virtual models using three-dimensional scans of a patient's dentition generated captured intraoral scanners is less than ideal for a number of reasons. The scanning process may result in inaccuracies that negatively impact the quality of the three-dimensional model and the determined bite and associated articulation. For example, during the scanning process wherein an arch is scanned from one side of the arch to the other, accumulated errors in the stitching process may result in the distance between the molars in generated model being greater or less than the actual distance between molars.

Scans of the patient's jaw may also include additional errors, such as including twists or skew. For example, the absolute position of teeth on the right side of the jaw and the left side of the jaw may be different due to accumulated scan error during the scanning process. Such accumulated errors may approach 0.5 mm.

### SUMMARY

Accordingly, as will be described in greater detail below, the present disclosure describes various systems and methods for generating dental models for use in generating occlusion mapping and bite articulation by gathering additional data and/or correcting the scan data. The systems and methods disclosed herein may be used to generate an accurate three-dimensional models of the patient's dentition for use in generating occlusion maps and articulation models of a patient's dentition. Occlusion mapping is the analysis and visualization of the contact points between teeth in the upper and lower dental arches of a patient. Proper occlusion affects how patient's chew, the health of the gums, the longevity of dental restorations, and overall oral health. Inaccurate occlusion can lead to issues like tooth wear, temporomandibular joint disorders, and pain. An occlusion map may be a digital representation (visual or a numerical representation) showing where teeth are making contact and with what intensity or degree of contact.

In addition, the systems and methods described herein may improve the functioning of a computing device and related systems by reducing computing resources and overhead for acquiring scan data and generating three-dimensional models of the patient's dentition for use in generating occlusion maps bite articulation models of the patient's dentition, thereby improving processing efficiency of the computing device over conventional approaches. These systems and methods may also improve the field of dental treatment, including prosthodontics and orthodontics, by providing the practitioner with more accurate records of the patient dentition and its function, by analyzing data and carrying out methods that lead to more efficient use of dental resources and more accurate bite articulation models.

### INCORPORATION BY REFERENCE

All patents, applications, and publications referred to and identified herein are hereby incorporated by reference in their entirety and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 depicts a flow diagram for generating an occlusion map of a patient's dentition, in accordance with some embodiments;

FIG. 2 depicts examples of 3D models of a patient's dentition, in accordance with some embodiments;

FIG. 3 depicts an example of scan errors in 3D models of a patient's dentition, in accordance with some embodiments;

FIG. 4 depicts an example a lingual imaging apparatus and image data, in accordance with some embodiments;

FIG. 5 depicts an example of an occlusion map on a 3D model of the patient's dentition, in accordance with some embodiments;

FIG. 6 depicts an orthodontic aligner and patient's dental arch, in accordance with some embodiments;

FIG. 7A depicts a system of orthodontic aligners, in accordance with some embodiments;

FIG. 7B depicts a restorative object, in accordance with some embodiments;

FIG. 8 shows a method of orthodontic treatment, in accordance with some embodiments;

FIG. 9A shows a method of treatment planning, in accordance with some embodiments;

FIG. 9B shows a method of treatment planning for a restorative treatment, in accordance with some embodiments;

FIG. 10 shows a system for use in dental treatment, in accordance with some embodiments; and

FIG. 11 shows an intraoral scanning system, in accordance with some embodiments.

### DETAILED DESCRIPTION

The following detailed description and figures provide a better understanding of the features and advantages of the inventions described in the present disclosure in accordance with the embodiments disclosed herein. Although the detailed description and figures include many specific embodiments, these are provided by way of example only and should not be construed as limiting the scope of the inventions disclosed herein.

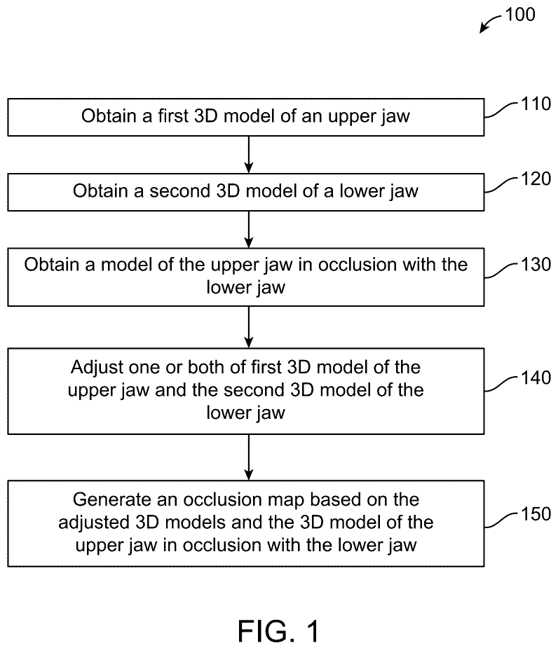

As shown in FIG. 1, an embodiment of a method 100 for generating a occlusion map of a patient's dentition is shown to include obtaining a first 3D model of an upper jaw of a patient at block 110, obtaining a second 3D model of a lower jaw of a patient at block 120, obtain a 3D model of the upper jaw in occlusion with the lower jaw at block 130, adjusting one or both of the first 3D model of the upper jaw and the second 3D model of the lower jaw at block 140, and generate an occlusion map based on the adjusted 3D models and the 3D model of the upper jaw in occlusion with the lower jaw at block 150.

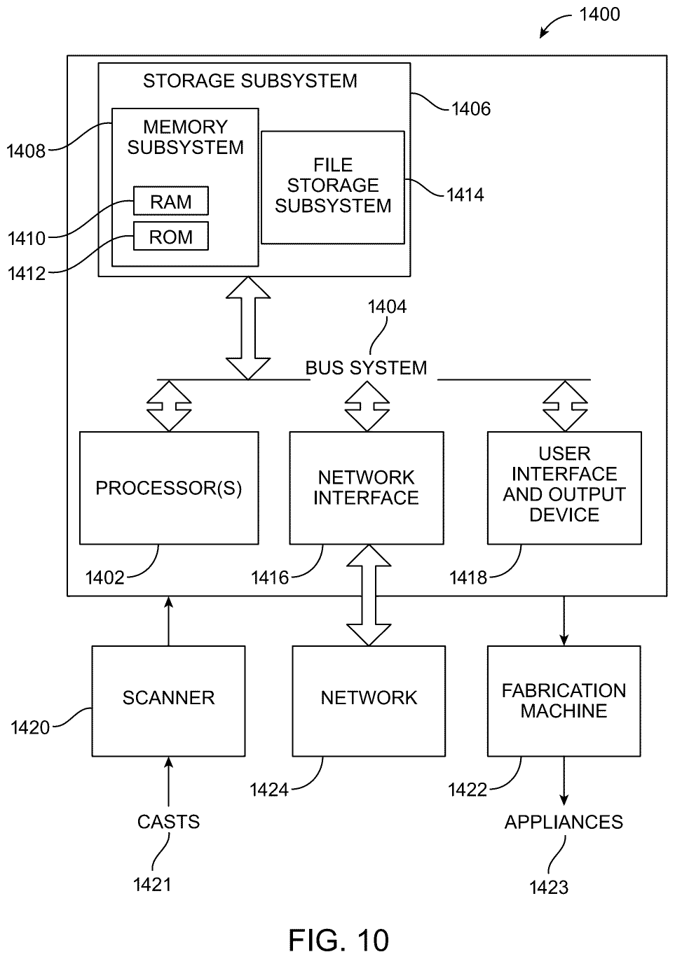

The process shown in FIG. 1 may be performed by any suitable computer-executable code and/or computing system, including the system(s) illustrated in FIG. 10. In one example, each of the steps of the process 100 shown in FIG. 1 may represent an algorithm whose structure includes and/or is represented by multiple sub-steps, examples of which will be provided in greater detail below.

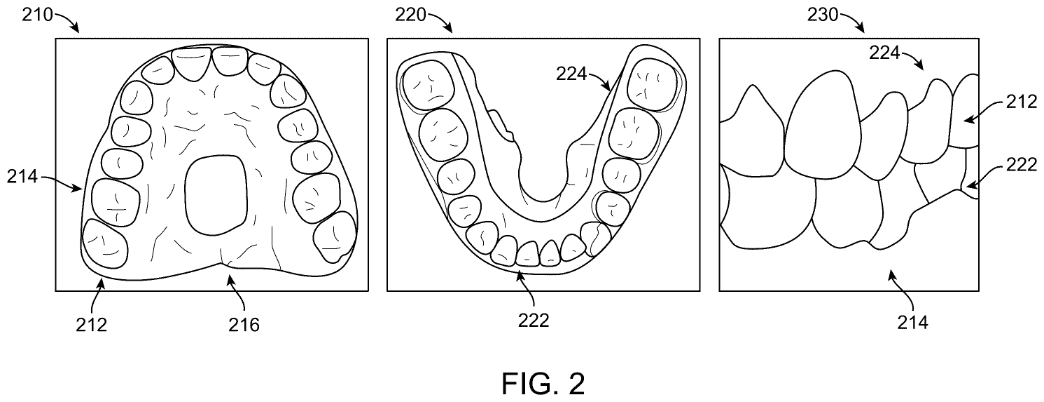

At block 110, the method may include obtaining a first 3D model of an upper jaw of a patient. FIG. 2 depicts a three-dimensional model 210 of the patient's upper jaw. In some embodiments, a system, such as a scanning system 1120 or a remote system, which may include a processor and member having instructions to carry out the methods described herein, may request a first 3D model of an upper jaw of a patient. The three-dimensional model 210 of the patient's upper jaw may include three-dimensional features of the patient's teeth 212, gingiva 214, and palate 216.

A scanner, such as an intraoral scanner, may be used to generate scan data, such as surface topography data, by scanning the patient's dentition. The intraoral scanner may provide the scan data to a system, such as a remote system. The surface topography data can be generated by directly scanning the intraoral cavity, a physical model (positive or negative) of the intraoral cavity, or an impression of the intraoral cavity, using a suitable scanning device (e.g., a handheld scanner, desktop scanner, coordinate measuring machine, etc.). During the scanning process, individual frames or images of the patient's teeth may be used to generate the first 3D model of the upper jaw the patient. The first 3D model of the upper jaw of the patient may include 3D data representing the surface contours and shape of the patient's dentition along with color data representing the color of the patient's anatomy associated with the surface of the patient's teeth, gums, and other oral anatomy. The scan data may be stitched together to generate a 3D model of the patient's dentition, such as the upper jaw of the patient. The 3D model of the patient's dentition may include lingual, buccal, and occlusal surfaces of the patient's teeth along with buccal and lingual surfaces of the patient's gingiva. The scan data may include digital representations of a patient's teeth. The digital representation, such as the two-dimensional or three-dimensional models may include surface topography data for the patient's intraoral cavity (including teeth, gingival tissues, etc.). The surface topography data can be generated by directly scanning the intraoral cavity, using a suitable scanning device (e.g., a handheld scanner). The first 3D model may include all of the teeth of the patient's upper jaw.

In some embodiments, the scan data may include near infrared images and data representing subsurface structures and features of the patient's dentition or other parts of the oral cavity, such as the gingiva. Near infrared illumination can penetrate the surface of the patient's teeth and gingiva to illuminate subsurface features for capture by an image sensor that is sensitive to near infrared wavelengths of light. The subsurface data may be aligned with the three-dimensional model of the patient's teeth during the scanning process. In some embodiments the 3D model may be a volumetric model and the subsurface data may be added at subsurface locations of the 3D model that correspond to the subsurface locations of the features in the physical world.

At block 120, the method may include obtaining a second 3D model of a lower jaw of a patient. In some embodiments, a system, such as a scanning system 1120 or a remote system, which may include a processor and member having instructions to carry out the methods described herein, may request a second 3D model of an lower jaw of a patient. FIG. 2 depicts a three-dimensional model 220 of the patient's lower jaw. The three-dimensional model 220 of the patient's lower jaw may include three-dimensional features of the patient's teeth 222, gingiva 224, and palate 226.

A scanner, such as an intraoral scanner, may be used to generate scan data by scanning the patient's dentition. The intraoral scanner may provide the scan data to a system, such as a remote system. During the scanning process, individual frames or images of the patient's teeth may be used to generate the first 3D model of the lower jaw the patient. The first 3D model of the lower jaw of the patient may include 3D data representing the surface contours and shape of the patient's dentition along with color data representing the color of the patient's anatomy associated with the surface of the patient's teeth. The scan data may be stitched together to generate a 3D model of the patient's dentition, such as the lower jaw of the patient. The 3D model of the patient's dentition may include lingual, buccal, and occlusal surfaces of the patient's teeth along with buccal and lingual surfaces of the patient's gingiva. The scan data may include digital representations of a patient's teeth. The digital representation, such as the two-dimensional or three-dimensional models may include surface topography data for the patient's intraoral cavity (including teeth, gingival tissues, etc.). The surface topography data can be generated by directly scanning the intraoral cavity, using a suitable scanning device (e.g., a handheld scanner).

In some embodiments, the scan data may include near infrared images and data representing subsurface structures and features of the patient's dentition. Near infrared illumination can penetrate the surface of the patient's teeth and gingiva to illuminate subsurface features for capture by an image sensor that is sensitive to near infrared wavelengths of light. The subsurface data may be aligned with the three-dimensional model of the patient's teeth during the scanning process. In some embodiments, the 3D model may be a volumetric model and the subsurface data may be added at subsurface locations of the 3D model that correspond to the subsurface locations of the features in the physical world.

In some embodiments, obtaining the first 3D model of the lower jaw of the patient may include capturing images of features associated with the patient's dentition. In some embodiments, the features may include natural features, such as anatomic features of the patient's dentition. In some embodiments, the 3D model of the patient's lower jaw may include all of the teeth of the patient's upper jaw. In some embodiments, the 3D model of the patient's lower jaw may include fewer than all of the teeth of the patient's upper jaw.

At block 130, the method may include capturing a model of the upper jaw in occlusion with the lower jaw. In some embodiments, a system, such as a scanning system 1120 or a remote system, which may include a processor and member having instructions to carry out the methods described herein, may request a second 3D model of an lower jaw of a patient. FIG. 2 depicts a three-dimensional model 320 of the patient's lower jaw in occlusion with the patient's upper jaw. The three-dimensional model 230 of the patient's lower jaw in occlusion with the patient's upper jaw may include three-dimensional features of the teeth 212, 222 of the patient's upper jaw and lower jaw, gingiva 214, 224 of the patient's upper jaw and lower jaw, and palate 226.

Similar to the capture of the 3D models of the patient's upper and lower jaws, capturing a model of the upper jaw in occlusion with the lower jaw may include using a scanner, such as an intraoral scanner, may be used to generate scan data by scanning the patient's dentition. The intraoral scanner may provide the scan data to a system, such as a remote system. During the scanning process, individual frames or images of the patient's teeth may be used to generate the third 3D model of the lower jaw in occlusion with the upper jaw. The third 3D model of the lower jaw in occlusion with the upper jaw may include 3D data representing the surface contours and shape of the patient's dentition along with color data representing the color of the patient's anatomy associated with the surface of the patient's teeth. The scan data may be stitched together to generate a 3D model of the patient's dentition including the lower jaw in occlusion with the upper jaw. The 3D model of the patient's lower jaw in occlusion with the upper jaw may include lingual, buccal, and occlusal surfaces of the patient's teeth along with buccal and lingual surfaces of the patient's gingiva. The scan data may include digital representations of a patient's teeth. The digital representation, such as the two-dimensional or three-dimensional models may include surface topography data for the patient's intraoral cavity (including teeth, gingival tissues, etc.). The surface topography data can be generated by directly scanning the intraoral cavity, using a suitable scanning device (e.g., a handheld scanner). The third 3D model of the lower jaw in occlusion with the upper jaw may include a very small area of contact as well as large areas that includes multiple teeth. In some embodiments, the third 3D model of the lower jaw in occlusion with the upper jaw may be generated based on scans of small areas of contact, such as one or two lower teeth in occlusion with one or two upper teeth and/or large areas that include multiple lower teeth, such as 3-5, in occlusion with multiple upper teeth, such as 3-5. In some embodiments, the third 3D model of the lower jaw in occlusion may include anterior teeth or only anterior teeth. In some embodiments, the third 3D model of the lower jaw in occlusion may include less than the all the patient's teeth. In some embodiments, the third 3D model of the lower jaw in occlusion may include a portion of the buccal side of the teeth of the left side of the upper and lower arches, a portion of the buccal side of the teeth of the right side of the upper and lower arches, and/or a portion of the buccal side of the teeth of the anterior teeth of the upper and lower arches. In some embodiments, the third 3D model of the lower jaw may have gaps in data between the positions.

In some embodiments, a prompt may be provided for the scanner operator to capture a first posterior scan of a first side of the arches in occlusion, such as a left side of the arches in occlusion. In some embodiments, the prompt may be displayed on a display, such as a screen of the scanning system. In some embodiments, an image or a model of the first side of an upper and lower arch in occlusion may be displayed. The image or model may include an indication of the portion of the left side of the arches in occlusion to be scanned. The indication may be a highlight of the teeth or area to be scanned, a perimeter of the teeth or area to be scanned overlayed on the image or model, or another indication. In some embodiments, the indication may include the tooth number or names that are to be scanned. The image or model may be a generic model of an upper and lower arch in occlusion. In some embodiments, the image may be an image or images of the patient's upper and lower arch in occlusion, such as based on the scan data gathered at blocks 110 and 120. In some embodiments, the model may be a model or models of the patient's upper and lower arch in occlusion, such as based on the scan data gathered at blocks 110 and 120.

During the scanning process or after the scanning process has begun, in some embodiments, feedback may be provided, such as on a display, that the first posterior scan is incomplete or that additional areas of the teeth should be scanned. The system may receive scan data from the scanner and determine which teeth of the upper and lower arches have been scanned in occlusion. If the teeth match the desired teeth or portion of the detention to be scanned, such as the portion indicated, then the system may provide feedback that the scan is complete. If the teeth that are indicated or area indicated to be scanned has not yet been sufficiently scanned, then the system may provide additional feedback, such as by highlighting, or otherwise, as discussed herein, as to which teeth or areas of the patient's dentition are left to be scanned to complete the first posterior scan.

In some embodiments, the system may determine which teeth have been scanned and/or which teeth may be left to scan by comparing the scan data of the during the first posterior scan with the scan data from blocks 110 and 120 in occlusion or not in occlusion. The comparison may include aligning the scan data from the first posterior scan with the scan data from block 110 and 120 to determine which locations, areas, and/or teeth are contained or not contained within the first poster scan data.

In some embodiments, a prompt may be provided for the scanner operator to capture a second posterior scan of a second side of the arches in occlusion, such as a right side of the arches in occlusion. In some embodiments, the prompt may be displayed on a display, such as a screen of the scanning system. In some embodiments, an image or a model of the second side of an upper and lower arch in occlusion may be displayed. The image or model may include an indication of the portion of the left side of the arches in occlusion to be scanned. The indication may be a highlight of the teeth or area to be scanned, a perimeter of the teeth or area to be scanned overlayed on the image or model, or another indication. In some embodiments, the indication may include the tooth number or names that are to be scanned. The image or model may be a generic model of an upper and lower arch in occlusion. In some embodiments, the image may be an image or images of the patient's upper and lower arch in occlusion, such as based on the scan data gathered at blocks 110 and 120. In some embodiments, the model may be a model or models of the patient's upper and lower arch in occlusion, such as based on the scan data gathered at blocks 110 and 120.

During the scanning process or after the scanning process has begun, in some embodiments, feedback may be provided, such as on a display, that the second posterior scan is incomplete or that additional areas of the teeth should be scanned. The system may receive scan data from the scanner and determine which teeth of the upper and lower arches have been scanned in occlusion. If the teeth match the desired teeth or portion of the detention to be scanned, such as the portion indicated, then the system may provide feedback that the scan is complete. If the teeth that are indicated or area indicated to be scanned has not yet been sufficiently scanned, then the system may provide additional feedback, such as by highlighting, or otherwise, as discussed herein, as to which teeth or areas of the patient's dentition are left to be scanned to complete the second posterior scan.

In some embodiments, the system may determine which teeth have been scanned and/or which teeth may be left to scan by comparing the scan data of the during the second posterior scan with the scan data from blocks 110 and 120 in occlusion or not in occlusion. The comparison may include aligning the scan data from the second posterior scan with the scan data from block 110 and 120 to determine which locations, areas, and/or teeth are contained or not contained within the second posterior scan data.

In some embodiments, a prompt may be provided for the scanner operator to capture an anterior scan of the arches in occlusion, such as a scan that includes anterior teeth, such as the incisors. In some embodiments, the prompt may be displayed on a display, such as a screen of the scanning system. In some embodiments, an image or a model of the second side of an upper and lower arch in occlusion may be displayed. The image or model may include an indication of the portion of the left side of the arches in occlusion to be scanned. The indication may be a highlight of the teeth or area to be scanned, a perimeter of the teeth or area to be scanned overlayed on the image or model, or another indication. In some embodiments, the indication may include the tooth number or names that are to be scanned. The image or model may be a generic model of an upper and lower arch in occlusion. In some embodiments, the image may be an image or images of the patient's upper and lower arch in occlusion, such as based on the scan data gathered at blocks 110 and 120. In some embodiments, the model may be a model or models of the patient's upper and lower arch in occlusion, such as based on the scan data gathered at blocks 110 and 120.

During the scanning process or after the scanning process has begun, in some embodiments, feedback may be provided, such as on a display, that the anterior scan is incomplete or that additional areas of the teeth should be scanned. The system may receive scan data from the scanner and determine which teeth of the upper and lower arches have been scanned in occlusion. If the teeth match the desired teeth or portion of the detention to be scanned, such as the portion indicated, then the system may provide feedback that the scan is complete. If the teeth that are indicated or area indicated to be scanned has not yet been sufficiently scanned, then the system may provide additional feedback, such as by highlighting, or otherwise, as discussed herein, as to which teeth or areas of the patient's dentition are left to be scanned to complete the anterior scan.

In some embodiments, the system may determine which teeth have been scanned and/or which teeth may be left to scan by comparing the scan data of the during the anterior scan with the scan data from blocks 110 and 120 in occlusion or not in occlusion. The comparison may include aligning the scan data from the anterior scan with the scan data from block 110 and 120 to determine which locations, areas, and/or teeth are contained or not contained within the anterior scan data.

In some embodiments, the scan data may include near infrared images and data representing subsurface structures and features of the patient's dentition. Near infrared illumination can penetrate the surface of the patient's teeth and gingiva to illuminate subsurface features for capture by an image sensor that is sensitive to near infrared wavelengths of light. The subsurface data may be aligned with the three-dimensional model of the patient's teeth during the scanning process. In some embodiments, the 3D model may be a volumetric model and the subsurface data may be added at subsurface locations of the 3D model that correspond to the subsurface locations of the features in the physical world.

In some embodiments, 2D images of the upper and lower jaws of the patient may be captured the lower jaw in occlusion with the upper jaw. A scanner, such as an intraoral scanner, may be used to generate 2D scan data by imaging the patient's dentition. The scanner may be the same scanner used to generate the 3D models of the upper and lower jaw of the patient. In some embodiments, the scanner may be a different scanner than the scanner used to generate the 3D models of the upper and lower jaws of the patient. During the scanning process, individual frames or images of the patient's teeth may be captured while the patient's upper jaw and lower jaw are in occlusion.

Each frame of 2D scan data generated by the scanner includes features of both the upper and lower jaws of the patient. The first 2D scan data may include color and other feature data representing the colors and features of the patient's anatomy associated with the surface of the patient's teeth. In some embodiments, the individual frames or images of the 2D scan data may be stitched together to generate larger images of the patient's dentition, including both the upper and lower jaw. The 2D images of the patient's dentition may include predominantly images of the buccal surfaces of the patient's dentition. In some embodiments, the images may include lingula, buccal, incisal, and/or the occlusal surfaces of the patient's dentition.

In some embodiments, the 2D scan data may include near infrared images and data representing subsurface structures and features of the patient's dentition. Near infrared illumination can penetrate the surface of the patient's teeth and gingiva and illuminate subsurface features for capture by an image sensor that is sensitive to near infrared wavelengths of light. The subsurface data may be aligned with the 2D surface images of the patient's dentition.

In some embodiments, 2D images of the patient's dentition may include capturing images of features associated with the patient's dentition. In some embodiments, the features may include natural features, such as anatomic features of the patient's dentition.

At block 140, the method may include adjusting one or both of first 3D model of the upper jaw and the second 3D model of the lower jaw.

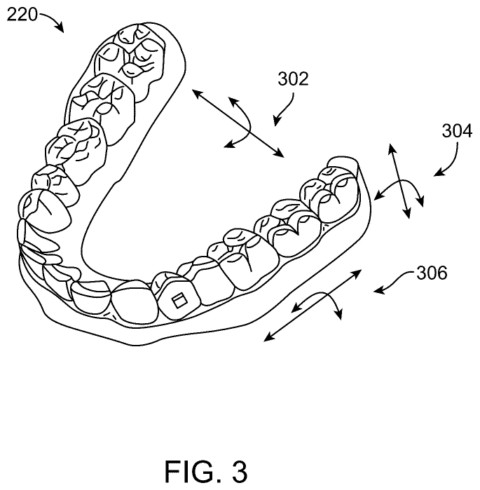

FIG. 3 depicts the three-dimensional model 220 of the patient's lower jaw. The three-dimensional model of the patient's dentition generated during the scanning process may include one or more errors. In some embodiments, the errors may be accumulated errors generated as a result of the stitching process. In some embodiments, other errors may include a lack of data caused by the scanner operator moving the intraoral scanner too fast (such as faster than an accurate scan may be produced), or a result of saliva on the teeth or even using a scanner that is out of calibration. The systems and methods herein may provide an improved occlusion map, even if or when they do not produce a correct arch width. As discussed above, when discussing the model generation process at blocks 110, 120, 130, and intraoral scanner may take many images of the patient's dentition the images may be used to generate point clouds that represented the surfaces in each of the images. The point clouds are then stitched together in order to generate a full 3D model of the patient's dentition. During the stitching process overlapping portions of the point clouds are aligned with each other by finding common surface features in the stitch images and then aligning the common features in order to align the overall point clouds. During this process errors in alignment may accumulate. For example, small errors in the alignment of each of the point clouds may result in relatively large errors in the overall model.

The errors may be errors in size and/or orientation. For example, as shown in FIG. 3, the errors may be an error in an arch width 302 at the molars. When the scans are stitched together the distance between the molars may be greater or less than the actual distance between the molars in the patient's actual anatomy. Similarly, a twist or skew may be generated across the arch wherein one side of the arch may be higher or lower than the other side of the arch. In some embodiments other errors such as errors in the length of the arch 306 may be generated. For example, small errors in stitching may result in a lengthening in a mesial-distal direction of one or both sides of the arch as compared to the patient's actual anatomy. In some embodiments other errors such as errors 304 in the height of the teeth may be generated during stitching. In some embodiments the teeth or the scan data may also be rotated in a buccal lingual direction about the mesial distal axis as compared to the patient's actual anatomy. While some errors are discussed herein other errors may also be generated during the scanning process. The areas may be generally described as errors in the dimensions or size of the patient's dentition such as lengths, widths, and height, and also may be rotational errors or deformities such as a skew between the right and left sides of the arch, rotations of the arch or other rotational errors.

In some embodiments, individual teeth may have positional errors. For example, during the scan of the upper jaw in occlusion with the lower job, the patient may apply forces to their teeth causing individual teeth to shift under the occlusal forces during the scan. In some embodiments, the teeth of the scan data may be segmented, such that each individual tooth of the model is separated from each other tooth. Such segmentation may facilitate movement of individual teeth to correct positional errors.

At block 140, of FIG. 1, such errors may be corrected. In some embodiments, parameters of the digital models may be adjusted in order to change their shape. Parameters may include parameters related to the errors discussed above such as arch with which may be the distance between the molars of opposite sides of the arch, arch length such as the distance between the molars and the incisors, the height of the arch which may be the distance between the occlusal surfaces and the gingival services of the patient's arch, and may also include rotation or skew such as the difference in height positions of the patient's left and right sides of the arches. Parameters may also include the positions and/or rotations of individual teeth.

In some embodiments, adjusting the parameters may include aligning the individual three-dimensional models of the upper arch and lower arch with the model of the patient's teeth in occlusion and then adjusting the parameters of the three-dimensional model of the upper arch and lower arches such that the surfaces in the three-dimensional models of the upper arch and lower arch match the corresponding surfaces, such as the teeth and gingiva, of the model of the patient's upper arch and lower arches in occlusion.

In some embodiments, the adjustments at block 140 are implemented by optimizing a distortion function that maps the vertices of the stitched 3-D meshes to a new position while preserving local detail. The distortion functions may be parameterized, such as using the parameters described herein.

In some embodiments, loss function may be used in order to adjust the models. The loss function may be used to minimize the overall differences between the individual three-dimensional models of the patient's upper and lower arches as compared to the three-dimensional model of the patient's upper and lower arch in occlusion. The distortion function may be iteratively adjusted, based on the loss function.

Adjusting of the parameters may result in changing the width of the patient's arch such as the distance between the patient's left molars and write molars to increase or decrease the distance. Adjusting the parameters may also result in changing the length of the arch such as the distance between the patient's left and/or write molars and one or more of the patient's incisors. In some embodiments, adjusting the parameters may result in changing the rotation of the patient's teeth about a mesial distal axis. In some embodiments adjusting the parameters may result in changing the skew of the left and right portions of the patient's arch.

In some embodiments, in addition to or in place of adjusting the length, width, skew, or other dimensions of the models of the upper arch and lower arch, the scan data itself may and adjusted, such as my restitching the scan data to adjust the model of the upper and/or lower arch. During the scanning process scan data is captured in frames as the scanner is moved about the mouth. Each frame of scan data may be converted to a point cloud. The points of a point cloud represent the surface structure identified in a frame of scan data. During the stitching process, each frame of scan data is aligned with adjacent frames and to the overall model to build the digital models of the aches. However, the individual frames of scan data may be retained, even after the initial models are built. During the optimization or alignment process, the individual frames of scan data may be restitched to correct accumulated scan errors and/or to improve the occlusion and alignment of the upper arch with the lower arch.

As discussed above, in some embodiments the scan of the patient's upper arch and lower arches in occlusion may include errors caused by forces imparted on the patient's teeth. Natural teeth are held in part by the periodontal ligament which may deform to allow the patient's teeth to move in response occlusal forces. A dental implant, on the other hand may not have periodontal ligament and may be fixed in place.

Parameters of the scan of the patient's upper and lower arch in occlusion may be adjusted based on the position of a dental implant. For example if a patient's teeth of an arch change position relative to the dental implant, between the individual 3D model and the model of the patient's upper and lower arch and dentition, the position of one or more teeth in the model of the patient's upper and lower arch in occlusion may be adjusted to match or more closely match the position and orientation of the patient's teeth in the individual 3D model relative to the prepared tooth.

Similarly, a prepared tooth such as a tooth crown wherein the crown has been reduced in size in order to be prepared to receive a prosthetic such as a crown or bridge, may not contact a tooth crown put in opposing arch when the upper and lower arches are in occlusion. Parameters of the scan of the patient's upper and lower arch in occlusion may be adjusted based on the position of a prepared tooth. For example if a patient's teeth of an arch change position relative to the prepared tooth, between the individual 3D model and the model of the patient's upper and lower arch and dentition, the position of one or more teeth in the model of the patient's upper and lower arch in occlusion may be adjusted to match or more closely match the position and orientation of the patient's teeth in the individual 3D model the relative to the prepared tooth.

In some embodiments, tooth motion may be adjusted based on an initial occlusion map. For example an occlusion map may be generated based on an initial model of the model of the patient's upper arch in occlusion with the model of the patient's lower arch. The occlusion map may be used to determine where teeth of the upper arch contact teeth of the lower arch. Based on the occlusion map, a direction of the forces imparted between the arches may be predicted, such as based on the surface normals of the occlusal surfaces of the teeth at the contact locations. The positions of the teeth may be adjusted based on the predicted forces generated based on the occlusion map. In some embodiments, a minimization function may be used to adjust the parameters, including the positions and orientations of the patient's teeth. In some embodiments, the minimization function may penalize motion based on the magnitude of a displacement or rotation and a direction of the predicted force.

In some embodiments, the occlusion map may be used to determine which teeth do not come in contact with teeth of an opposing arch. Similar to the prepared tooth, parameters of the scan of the patient's upper and lower arch in occlusion may be adjusted based on the position of one or more teeth that are not in occlusion with teeth of an opposing arch. For example, if a patient's teeth of an arch change position relative to the non-occluded teeth, between the individual 3D model and the model of the patient's upper and lower arch and dentition, the position of one or more teeth in the model of the patient's upper and lower arch in occlusion may be adjusted to match or more closely match the position and orientation of the patient's teeth in the individual 3D model the relative to the nonoccluded teeth.

In some embodiments, artificial features, which may include features added to the patient's dentition in order to more clearly identify locations associated with the patient's jaw teeth, may be added to the patient's teeth. Such features may be added to the patient's teeth during the scan of the individual arches and or the scan of the upper arch and lower arches in occlusion. The features may include stickers temporarily adhered to the patient's teeth.

In some embodiments, one scan may generate a more accurate 3D model than another scan. For example, this may occur when one jaw was scanned more carefully or with more side to side connections than another job. Side to side connections may include the scanning of a patient's pallet resulting in a more accurate arch with for the upper jaw. As depicted in FIG. 2, the model 210 of the upper arch may include portions of the palate 216. The pallet provide side to side connections between the right side of the patient's upper arch and the left side of the patient's arch. These connections aid in more generating a more accurate arch with of the patient's dentition.

In some embodiments, features of the patient's anatomy may result in less accurate scans and models of the patient's arch. For example, stitching large smooth surfaces together may result in inaccurate stitching. Smooth surfaces such as smooth gingival surfaces resulting from the loss of a patient's tooth or multiple teeth, called edentloss regions, may have very smooth tissue.

In some embodiments, the accuracy of a patient's scan or the relative accuracy between may be estimated based on one or more factors. For example, a scan of an upper arch wherein the palate was scanned may be estimated to be more accurate than a scan of a lower arch where the palate was not scanned. In some embodiments, the existence of edentloss regions may indicate a lower quality scan as compared to a scan without edentloss regions. In some embodiments, the accuracy of a scan may be estimated based on the scan data and how the scan data was stitched together. For example, scan data wherein there is significant overlap between the generated point clouds may result in a more accurate stitching and model than scan data wherein there is less significant overlap between the generated point clouds. Other factors may be used to determine the accuracy or relative accuracy of a model and the stitching used to generate the model.

In some embodiments, if one jaw is estimated to have higher accuracy than another, the higher accuracy model may be unmodified while the lower accuracy model is adjusted, such as through adjusting its parameters, to fit the higher accuracy model.

In some embodiments, each of the adjustments discussed herein may be used as part of the minimization function in order to adjust one or more of the models. Each of the models and/or the parameters associated with the models may be weighted relative to one another based on one or more factors. For example, higher quality scans may be favored for fewer changes while lower quality scans may be favored for more changes. The weights may be assigned to each model. In some embodiments, one or more constraints may be placed on the optimization or adjustment of the models to place the upper arch in occlusion with the lower arch. For example, a constraint may be based on the type of objects within the scan. For example, the positions of teeth that are less likely to move, such as prepared teeth and implants may be favored over positions of teeth that are more likely to move, such as teeth in contact with the teeth of the opposing arch, and other factors may be used. A constraint may include not changing the relative position of prepared teeth or implants during the optimization. Another constraint may include the stability of the arches when they are in occlusion. Stability of the arches may involve contact between the upper arch and the lower arch at multiple contact points. In some embodiments, stability may include multiple contact points on at least one side of the arch with at least one contact point on an opposite side of the arch. In some embodiments, stability may include multiple contact points on each side of the arch. The constraints on the alignment may include such stability constraints.

Another constraint may preclude penetration of one arch into another arch. In the physical world, teeth may contact each other, but they do not penetrate into each other during normal occlusion. However, in digital modeling and optimization, penetration may not be prevented unless a penetration constraint is included in the algorithm.

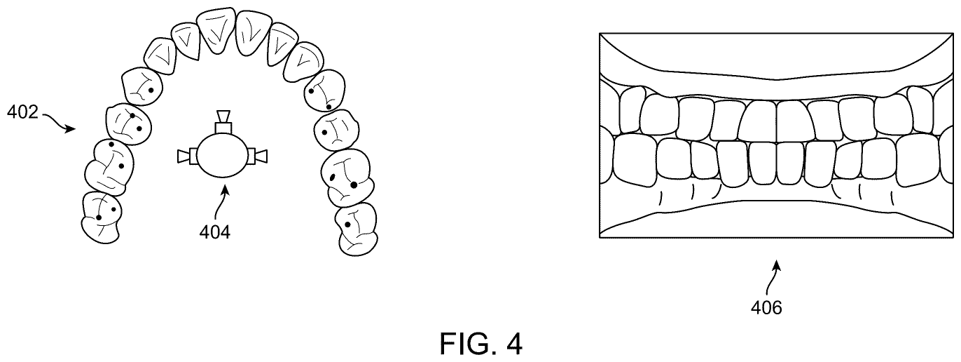

With reference to FIG. 4, in some embodiments, capture of the patient's dentition in occlusion from the lingual side may be used to adjust the models. FIG. 4 depicts the position of a lingual camera 404 that may be placed within the patient's oral cavity such as on the tongue and held against the roof of the patient's mouth within the arch 402 of the patient's dentition. The lingual camera 404 may include one or more image sensors and corresponding lenses to capture the patient's arch. In some embodiments, the lingual camera may capture less than all of the teeth of the patient's arch. The image 406 of the patient's dentition in occlusion may be used to provide additional alignment surfaces for alignment of the individual upper arch and lower arch models. In some embodiments, the lingual camera 404 may be a three-dimensional scanner which may generate point clouds from one or more of the image sensors and corresponding lenses that may be stitched together to generate a three-dimensional model of the lingual services of the patient's teeth in occlusion.

In some embodiments the camera may wirelessly transmit images or other scan data to a mobile device or other computing device in order to provide real time or near real time images. The patient or doctor may manipulate the camera within the oral cavity in order to adjust the field of view of the camera 406. The lingual images of the upper and lower arch in occlusion may be used in addition to or instead of the occlusal images of the patient's upper and lower arch in occlusion discussed above.

Returning to FIG. 1, at block 150 the occlusion contacts are calculated, and an occlusion map may be generated using the adjusted models of the upper and lower arch in occlusion. In some embodiments, occlusion contacts may be calculated, and an occlusion map may be generated using the unadjusted or original models of the upper and lower arch in occlusion. The occlusion contacts between the model of the patient's upper arch and the model of the patient's lower arch may be determined using the relative position of the teeth of the patient's lower arch with respect to the teeth of the patient's upper arch. An occlusal map of the occlusion contacts may be generated based on the contacts. An occlusal map may include the location and degree of contact between the teeth of the patient's upper arch and the teeth of the patient's lower arch. The occlusal map may include information such as the distance between a location on a surface of a tooth of one of the patient's upper or lower arch and a surface of a occluding tooth on the other one of the patient's upper or lower arch. In some embodiments, the distance is measured from the surface of the first tooth to the surface of the second tooth along a direction perpendicular to an occlusal plane of the patient's arch. In some embodiments, the distance is measured from the surface of the first tooth to the nearest surface of the second tooth, which may or may not be in a direction perpendicular to the occlusal plane of the patient's arch.

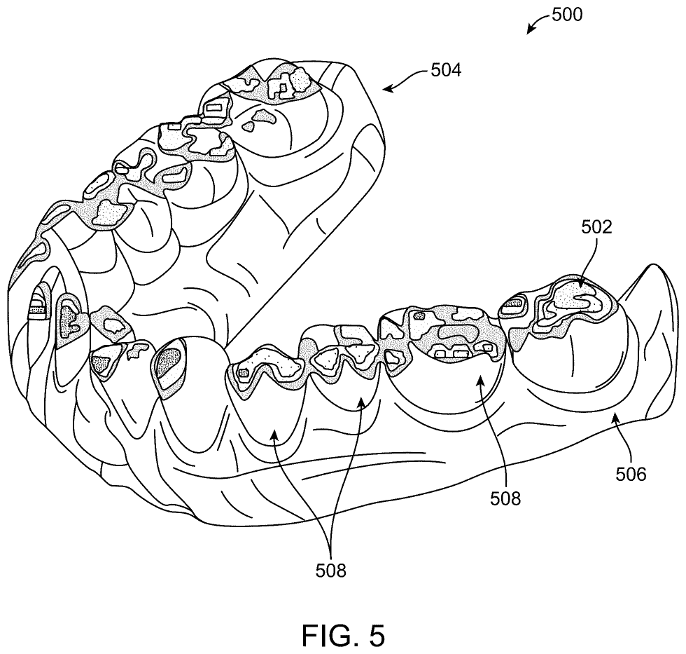

FIG. 5 depicts an example of an occlusion map generated based on the occlusion contacts generated using the adjusted models discussed herein. The occlusion map 500 depicts a three-dimensional model of the lower arch 504 of the patient including the gingiva 506 and each of the teeth 508 of the patient's lower arch 504. The surfaces of the patient's teeth 508 are shaded to depict the degree of occlusion in occlusion map 502. The occlusion map 502 shows the relative extent of the occlusion contacts or distance between occlusal surfaces based on the shading of the respective tooth surfaces provide a digital visualization of the distance data generated at block 150. A similar occlusion map may be generated for the upper arch of the patient.

In some embodiments, the occlusion map or maps generated using the adjusted models may be displayed simultaneously with the occlusion map or maps generated using the unadjusted models. In some embodiments, the occlusion maps may be displayed in succession or repeating succession for analysis and review, such as by receiving in input to switch between them or automatically. In some embodiments, a selection may be received by and/or provided to the system which map or maps should be used for analyzing the occlusion contacts. For example, the selection may be a selection of a map or maps to keep or of a map or maps to reject. Treatment and analysis may then proceed with the appropriate map or maps. In some embodiments, if the adjusted map or maps are not selected or are determined to be insufficient or inadequate, then the process may return to block 110, 120, and/or 130 for rescan of one or more of the upper jaw, lower jaw, and upper jaw in occlusion with the lower jaw before proceeding back to blocks 140 and 150.

In some embodiments, the scan data, such as one or more of the upper arch, lower arch, or the upper and lower arch in occlusion may be displayed with the occlusion map or maps, such as simultaneously and/or side by side. In some embodiments, the adjusted arches either alone, together, or in occlusion may be disabled with the occlusion map or maps, such as simultaneously and/or side by side.

In some embodiments, a threshold may be applied to the shading of the occlusion map such that if a distance is above the threshold, the distance may not be shaded. For example, occlusal distances greater than 1 mm may not be shaded while occlusal distances between zero and 1 mm may be assigned a shade or color that corresponds to an occlusal distance between zero and 1 mm. In some embodiments, occlusal distances closer to 0 mm may be assigned a red color while occlusal distances closer to 1 mm may be assigned a green color while distances in between those assigned to the red and green colors may be shaded in other colors, such as yellow and orange. Such visualizations may aid a dental practitioner in evaluating the extent of the occlusal contacts and aid in determining an appropriate dental treatment to correct any malocclusions.

The process described above, in some embodiments, for example, in a crown fitting procedure scans of the patient's upper and lower arches along with the upper and lower arches in occlusion as described in FIG. 1 may be used to generate an occlusion map after a crown has been placed on the patient's dentition. The occlusion map may be used to suggest removal of undesirable contacts. A doctor may rely on the occlusion map to determine whether or not to remove the undesirable contacts, such as contacts that interfere with proper occlusion of the patient's arches. In some embodiments, these may be referred to as interfering contacts which may be locations where an occlusion surface of a first arch interferes with an occlusal surface of a second arch beyond a threshold distance of interference.

The doctor may then rescan the patient's upper and lower arches in the upper and lower arches in occlusion to determine whether or not undesirable contacts have been removed.

In some embodiments, the patient's treatment and corresponding occlusal map may be tracked over time. For example a patient may use a camera positioning device, such as the iTero Tube, to periodically take images of their dentition using a personal camera such as a camera on a smart phone. The images may be two-dimensional images. In some embodiments, the two-dimensional images of the patient's teeth may include two-dimensional images of the patient's teeth in occlusion.

After having captured the relative position of the patient's arches which may be in static or dynamic occlusion and articulation (such as, including images of the patient's arches in different relative occlusion positions such as shifting side to side or front to back) the initial or other existing models of the individual arches of the patient's dentition and the teeth therein, such as the models generated using the method of FIG. 1 may be aligned with the arches and teeth in the images captured by the patient. An updated occlusion map may be generated based on the images captured by the patient and the three-dimensional images previously captured using for example an intraoral scanner.

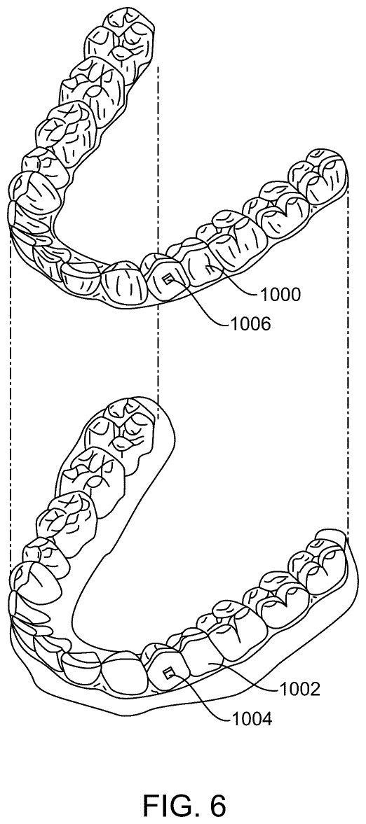

FIG. 6 illustrates an exemplary tooth repositioning appliance 1000, such as an aligner that can be worn by a patient in order to achieve an incremental repositioning of individual teeth 1002 in the jaw. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. The physical model (e.g., physical mold) of teeth can be formed through a variety of techniques, including 3D printing. The appliance can be formed by thermoforming the appliance over the physical model. In some embodiments, a physical appliance is directly fabricated, e.g., using additive manufacturing techniques, from a digital model of an appliance. In some embodiments, the physical appliance may be created through a variety of direct formation techniques, such as 3D printing. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. In some embodiments, no wires or other means will be provided for holding an appliance in place over the teeth. In some cases, however, it may be desirable or necessary to provide individual attachments or other anchoring elements 1004 on teeth 1002 with corresponding receptacles or apertures 1006 in the appliance 1000 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

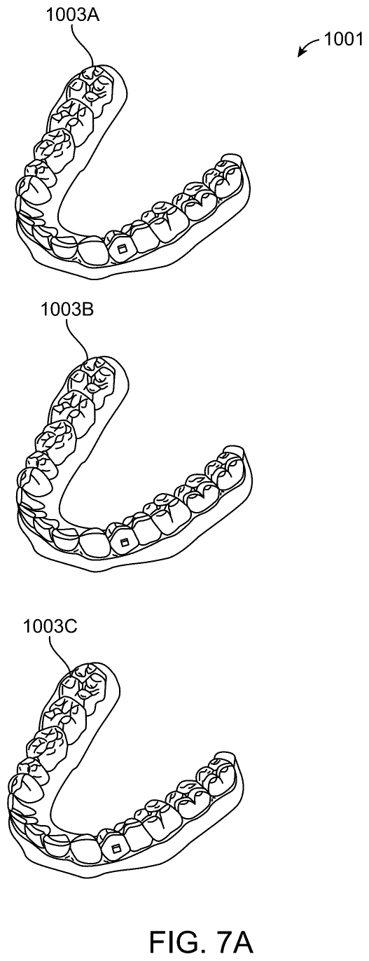

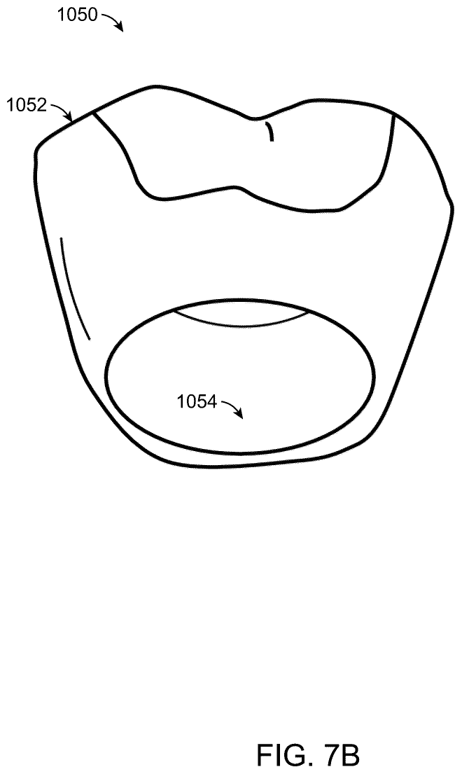

FIG. 7A illustrates a tooth repositioning system 1000 including a plurality of appliances 1003A, 1003B, 1003C. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 1000 can include a first appliance 1003A corresponding to an initial tooth arrangement, one or more intermediate appliances 1003B corresponding to one or more intermediate arrangements, and a final appliance 1003C corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

Optionally, in cases involving more complex movements or treatment plans, it may be beneficial to utilize auxiliary components (e.g., features, accessories, structures, devices, components, and the like) in conjunction with an orthodontic appliance. Examples of such accessories include but are not limited to elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems and methods described herein include improved orthodontic appliances with integrally formed features that are shaped to couple to such auxiliary components, or that replace such auxiliary components.

FIG. 7B depicts a restorative object 1050. The depicted restorative object is a crown, but may take the form of a bridge, veneer, inlay, onlay, or other dental prosthetic. The restorative object includes a body made of a thin, high-strength substructure made from zirconia, lithium-disilicate, or other materials, such as metal or hybrid resin-ceramic. The body is fabricated to fit the prepared tooth very closely. Bears occlusal loads and transferred them to the tooth on which it is placed. The body includes an outer surface 1052 that includes the outer shape of the restorative object and may colored or shaded to match the original tooth or adjacent teeth. The outer surface may also have the shape of the tooth that it is replacing or a corresponding tooth on the opposite side of the same dental arch or selected from a set of tooth shapes.

The inner surface 1054 or intaglio surface is the inside or tooth facing surface that faces the tooth on which the restorative object is placed. This surface is shaped to intimately fit the shape of the tooth on which it is placed to allow for transfer of occlusal loads into the tooth and to promote cement bonding between the restorative object, hygiene, and for esthetics.

Both the inner surface and the outer surface may be generated based on the adjusted 3D model of the patient's dentition.

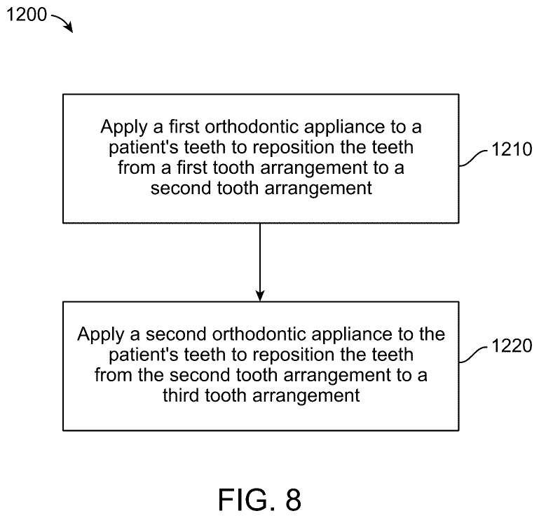

FIG. 8 illustrates a method 1200 of orthodontic treatment using a plurality of appliances, in accordance with many embodiments. The method 1200 can be practiced using any of the appliances or appliance sets described herein. In step 1210, a first orthodontic appliance is applied to a patient's teeth in order to reposition the teeth from a first tooth arrangement to a second tooth arrangement. In step 1220, a second orthodontic appliance is applied to the patient's teeth in order to reposition the teeth from the second tooth arrangement to a third tooth arrangement. The method 1200 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

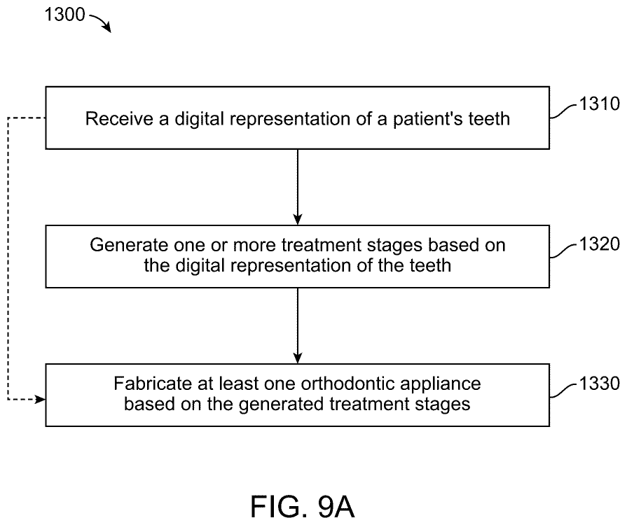

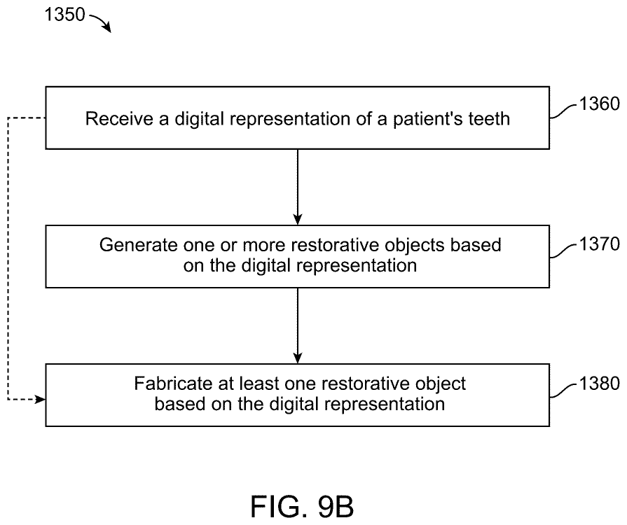

FIG. 9A illustrates a method 1300 for digitally planning an orthodontic treatment and/or design or fabrication of an appliance, in accordance with many embodiments. The method 1300 can be applied to any of the treatment procedures described herein and can be performed by any suitable data processing system. Any embodiment of the appliances described herein can be designed or fabricated using the method 1300.

In step 1310, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

The digital representation may include a digital model of the patient's upper or lower jaw generated according to the method of FIG. 1

In step 1320, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 1330, at least one orthodontic appliance is fabricated based on the generated treatment stages. For example, a set of appliances can be fabricated to be sequentially worn by the patient to incrementally reposition the teeth from the initial arrangement to the target arrangement. Some of the appliances can be shaped to accommodate a tooth arrangement specified by one of the treatment stages. Alternatively or in combination, some of the appliances can be shaped to accommodate a tooth arrangement that is different from the target arrangement for the corresponding treatment stage. For example, as previously described herein, an appliance may have a geometry corresponding to an overcorrected tooth arrangement. Such an appliance may be used to ensure that a suitable amount of force is expressed on the teeth as they approach or attain their desired target positions for the treatment stage. As another example, an appliance can be designed in order to apply a specified force system on the teeth and may not have a geometry corresponding to any current or planned arrangement of the patient's teeth.

In some instances, staging of various arrangements or treatment stages may not be necessary for design and/or fabrication of an appliance. As illustrated by the dashed line in FIG. 9A, design and/or fabrication of an orthodontic appliance, and perhaps a particular orthodontic treatment, may include use of a representation of the patient's teeth (e.g., receive a digital representation of the patient's teeth 1310), followed by design and/or fabrication of an orthodontic appliance based on a representation of the patient's teeth in the arrangement represented by the received representation.

FIG. 9B illustrates a method 1350 for digitally planning a restorative treatment and/or the design or fabrication of an appliance, such as a restorative object, in accordance with many embodiments. A restorative object may include a crown, but may take the form of a bridge, veneer, inlay, onlay, or other dental prosthetic.

The method 1350 can be applied to any of the treatment procedures described herein and can be performed by any suitable data processing system. Any embodiment of the restorative objects described herein can be designed or fabricated using the method 1350.

In step 1360, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

The digital representation may include a digital model of the patient's upper or lower jaw generated according to the method of FIG. 1

In step 1370, one or more restorative objects are generated based on the digital representation of the teeth, such as a 3D model. For example, an outer surface of the restorative object may be based on a scan, such as a scan discussed herein, of an external surface of a tooth before it is prepared (e.g., had material removed to accommodate the restorative object), or an external surface of the same type of tooth on the opposite side of the same arch. The internal surface of the tooth may be generated base don a scan, such as a scan discussed herein, generated after the tooth has been prepared. The inner surface of the restorative object may be based on the surface shape of the prepared tooth.

In step 1380, at least one restorative object is fabricated based on the 3D model of the restorative object. The restorative object may be directly fabricated, such as without the use of a mold. In some embodiments, the restorative object may be 3D printed or milled.

FIG. 10 is a simplified block diagram of a data processing system 1400 that may be used in executing methods and processes described herein. The data processing system 1400 typically includes at least one processor 1402 that communicates with one or more peripheral devices via bus subsystem 1404. These peripheral devices typically include a storage subsystem 1406 (memory subsystem 1408 and file storage subsystem 1414), a set of user interface input and output devices 1418, and an interface to outside networks 1416. This interface is shown schematically as “Network Interface” block 1416, and is coupled to corresponding interface devices in other data processing systems via communication network interface 1424. Data processing system 1400 can include, for example, one or more computers, such as a personal computer, workstation, mainframe, laptop, and the like.

The user interface input devices 1418 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 1406 maintains the basic required programming, including computer readable media having instructions (e.g., operating instructions, etc.), and data constructs. The program modules discussed herein are typically stored in storage subsystem 1406. Storage subsystem 1406 typically includes memory subsystem 1408 and file storage subsystem 1414. Memory subsystem 1408 typically includes a number of memories (e.g., RAM 1410, ROM 1412, etc.) including computer readable memory for storage of fixed instructions, instructions and data during program execution, basic input/output system, etc. File storage subsystem 1414 provides persistent (non-volatile) storage for program and data files, and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 1420 includes any means for obtaining a digital representation (e.g., images, surface topography data, etc.) of a patient's teeth (e.g., by scanning physical models of the teeth such as casts 1421, by scanning impressions taken of the teeth, or by directly scanning the intraoral cavity), which can be obtained either from the patient or from treating professional, such as an orthodontist, and includes means of providing the digital representation to data processing system 1400 for further processing. Scanner 1420 may be located at a location remote with respect to other components of the system and can communicate image data and/or information to data processing system 1400, for example, via a network interface 1424. Fabrication system 1422 fabricates appliances 1423 based on a treatment plan, including data set information received from data processing system 1400. Fabrication machine 1422 can, for example, be located at a remote location and receive data set information from data processing system 1400 via network interface 1424.

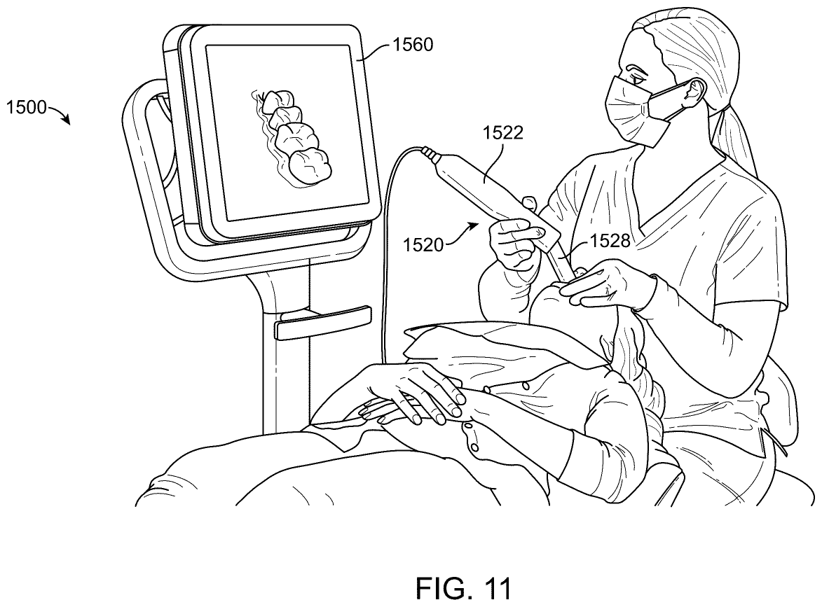

Reference is now made to FIG. 11, which illustrates an intraoral scanning system 1500, in accordance with some embodiments of the present invention. The intraoral scanning system 1500 comprises an elongate handheld wand 1522 that has a probe 1528 at distal end of the handheld wand 1522. Probe 1528 has a distal end and a proximal end. As used herein, the proximal end of the handheld wand is the end of the handheld wand that is closest to a user's hand when the user is holding the handheld wand in a ready-for-use position and the distal end of the handheld wand is the end of the handheld wand that is farthest from the user's hand when the user is holding the handheld wand in a ready-for-use position. The intraoral scanning system and/or the handheld wand may include some of all of the features and capabilities of the processing system 1400, depicted in and described with reference to FIG. 10. The intraoral scanning system and/or the handheld wand may be used to carry out the processes shown and described herein, such as those of FIGS. 1-5.

In some embodiments, an intraoral scanner may include an intraoral imaging system, such as a structured light projector disposed in proximal end of probe along with one or more light field cameras also disposed in proximal end of probe 1528. Although an embodiment of the intraoral 3D scanner may be include a structured light scanner. The system 1500 may use a 3D scanning probe using one or more of many different types of 3D scanning hardware and software. For example, the 3D scanning system may be a confocal 3D scanning system, a photogrammetry scanner, or other 3D scanning system type.

The intraoral scanner may include a camera and light sensor that comprises an image sensor comprising an array of pixels, e.g., a CMOS image sensor, or multiple cameras and/or sensors.

Intraoral scanning system 1500 may include control circuitry that controls the scanning process, such the projection of slight, such as a structured light pattern, onto intraoral tissue, such as teeth and gingiva, and the capture of light reflecting intraoral tissue. Using information from intraoral scanner, a computer processor may reconstruct a three-dimensional image of the surface of the intraoral tissue, such as the dentition discussed herein and may output the image to an output device 1560, e.g., a monitor. It is noted that computer processor, such as the processors 1102 of FIG. 10 is depicted by way of illustration and not limitation, and may be located outside of handheld wand 1522. In some embodiments, computer processors may be disposed within handheld wand 1522.

The intraoral scanning system may generate point clouds representing the three-dimensional surface of the intraoral tissue. The intraoral scanning system may generate up to 60 frames per second of point cloud data that may be used to generate a three-dimensional model of the surface of the intraoral tissue. In some embodiments, the point cloud data may be used to determine the position and orientation of the scanning wand with respect to the intraoral structure of the intraoral tissue being scanned.

In some embodiments, the scanning system may also capture the color of the surfaces of the intraoral tissue. For example, in some embodiments the scanning system may include a light source in or on the wand 1522. The light source may be a white light source and the camera may record the color of the surface of the intraoral tissue based on the light reflected from the object.

In some embodiments, optical elements other than mirrors or in addition to mirrors, such as optical fibers may be used to direct the light towards the dental object.

In some embodiments the light source may include a plurality of light sources. For example, the light source may be a plurality of LEDs or a two-dimensional array of light sources. In some embodiments, the light source may include a mask such as an LCD including a plurality of pixels arranged in a two-dimensional array. Activation and deactivation of the pixels in the array may control the amount and area of the light exiting the probe 1528.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters such as numerals refer to like elements.

As used herein, characters such as numerals refer to like elements.

The present disclosure includes the following numbered clauses.

Clause 1. A method of generating an occlusion map of a patient's dentition, comprising: receiving stitched 3D scan data of a patient's upper jaw; receiving stitched 3D scan data of a patient's lower jaw; receiving a model of the patient's upper jaw in occlusion with the patient's lower jaw; adjusting a shape of the one or both of the stitched 3D scan data of the patient's upper jaw and the stitched 3D scan data of the patient's lower jaw based on the model of the model of the patient's upper jaw in occlusion with the patient's lower jaw; generating occlusion map for the patient based on the adjusted 3D scan data of the upper jaw in occlusion with the adjusted 3D scan data of the lower jaw.

Clause 2. The method of clause 1, wherein the stitched 3D scan data of a patient's upper jaw is a 3D model of the patient's upper jaw and the stitched 3D scan data of a patient's lower jaw is a 3D model of the patient's lower jaw.

Clause 3. The method of clause 1, wherein 3D model of the patient's upper jaw includes all of the teeth of the upper arch of the patient and the receiving a 3D model of the patient's lower jaw includes all of the teeth of the lower arch of the patient.

Clause 4. The method of clause 1, wherein the model of the patient's upper jaw in occlusion with the patient's lower jaw includes anterior teeth.

Clause 5. The method of clause 1, wherein 3D model of the patient's upper jaw includes fewer than all of the teeth of the upper arch of the patient and the receiving a 3D model of the patient's lower jaw includes fewer than all of the teeth of the lower arch of the patient.

Clause 6. The method of clause 1, wherein the 3D model of the patient's upper jaw and the 3D model of the patient's lower jaw are adjusted in width, length, or height.

Clause 7. The method of clause 1, wherein adjusting the 3D model of the patient's upper jaw and the 3D model of the patient's lower jaw are adjusted using a distortion function that adjusts one or more parameters of the 3D model of the patient's upper jaw or 3D model of the patient's lower jaw.

Clause 8. The method of clause 7, wherein the distortion function is constrained by one or more loss functions.

Clause 9. The method of clause 1, wherein adjusting the 3D model of the patient's upper jaw and adjusting the 3D model of the patient's lower jaw further comprises estimating an accuracy of the 3D model of the patient's upper jaw and an accuracy of the 3D model of the patient's lower jaw and adjusting the 3D model of the patient's upper jaw based on the accuracy of the 3D model of the patient's upper jaw and adjusting the 3D model of the patient's lower jaw based on the accuracy of the 3D model of the patient's lower jaw.

Clause 10. The method of clause 9, wherein adjusting the 3D model of the patient's upper jaw and adjusting the 3D model of the patient's lower jaw further comprises assigning weights of one or more parameters of 3D model of the patient's upper jaw based on the accuracy of the model of the upper jaw and assigning weights of one or more parameters of 3D model of the patient's lower jaw based on the accuracy of the model of the lower jaw.

Clause 11. The method of clause 9, wherein the estimated accuracies are based on an existence or size of an endentuous region in the 3D model of the patient's upper jaw or of the 3D model of the patient's lower jaw.

Clause 12. The method of clause 9, wherein the estimated accuracies is based on an overlap of scan data associated with the 3D model of the patient's upper jaw or of the 3D model of the patient's lower jaw.

Clause 13. The method of clause 9, wherein the estimated accuracies is based on amount of scan data associated with the 3D model of the patient's upper jaw or of the 3D model of the patient's lower jaw.

Clause 14. The method of clause 9, wherein the estimated accuracies is based on palatal region included within the scan the 3D model of the patient's upper jaw.

Clause 15. The method of clause 1, wherein adjusting the 3D model of the patient's upper jaw and adjusting the 3D model of the patient's lower jaw further comprises estimating a relative accuracy of the 3D model of the patient's upper jaw with respect to the 3D model of the patient's lower jaw and adjusting the 3D model of the patient's upper jaw and the 3D model of the patient's lower jaw based on the relative accuracy of the 3D model of the patient's upper jaw compared to the 3D model of the patient's lower jaw.

Clause 16. The method of clause 15, wherein adjusting the 3D model of the patient's upper jaw and adjusting the 3D model of the patient's lower jaw further comprises assigning weights of one or more parameters of 3D model of the patient's upper jaw based on the relative accuracy of 3D model of the patient's upper jaw compared to the 3D model of the patient's lower jaw.

Clause 17. The method of clause 15, wherein the relative accuracy is based on an existence or size of an endentuous region in the 3D model of the patient's upper jaw or of the 3D model of the patient's lower jaw.

Clause 18. The method of clause 15, wherein the relative accuracy is based on an overlap of scan data associated with the 3D model of the patient's upper jaw or of the 3D model of the patient's lower jaw.

Clause 19. The method of clause 15, wherein the relative accuracy is based on amount of scan data associated with the 3D model of the patient's upper jaw or of the 3D model of the patient's lower jaw.

Clause 20. The method of clause 15, wherein the relative accuracy is based on palatal region included within the scan the 3D model of the patient's upper jaw.

Clause 21. The method of clause 1, wherein the occlusion map is applied to a 3D model of the patient's dentition.

Clause 22. The method of clause 1, wherein model of the patient's upper jaw in occlusion includes lingual surfaces of the patient's upper and lower jaw.

Clause 23. A method of generating an occlusion map of a patient's dentition, comprising: requesting a 3D model of the patient's upper detention; requesting a 3D model of the patient's lower dentition; requesting a model of the patient's anterior teeth while the upper dentition is in occlusion with the patient's lower dentition; adjusting the shape of the one or both of the 3D model of the patient's upper dentition and the 3D model of the patient's lower dentition based on the model of the patient's anterior teeth; generating occlusion map for the patient based on the adjusted model of the upper dentition in occlusion with the adjusted model of the lower dentition.

Clause 24. The method of clause 23, wherein the model of the patient's anterior teeth includes less than all of the patient's teeth.

Clause 25. The method of clause 23, wherein the model of the patient's anterior teeth includes only the patient's anterior teeth.

Clause 26. The method of clause 23, wherein the model of the patient's anterior teeth does not include molars.

Clause 27. The method of clause 23, further comprising: requesting a model of a first portion of a side of the patient's dental arches while the upper dentition is in occlusion with the patient's lower dentition.

Clause 28. The method of clause 27, wherein the first side is a left or right side of the patient's arches.

Clause 29. The method of clause 27, wherein the teeth of the patient captured in the model of the first side of the patient's dental arches are not included in the model of the patient's anterior teeth first side is a left or right side of the patient's arches.

Clause 30. The method of clause 23, further comprising: indicating, on a display, a location on the patient's dentition to capture scan data for the model of the patient's anterior teeth.

Clause 31. The method of clause 30, further comprising: indicating, on a display, a feedback for capturing additional scan data of the patient's anterior teeth.

Clause 32. A method of generating an occlusion map of a patient's dentition, comprising: requesting a 3D model of the patient's upper detention; requesting a 3D model of the patient's lower dentition; requesting a model of the patient's anterior teeth while the upper dentition is in occlusion with the patient's lower dentition; adjusting the shape of the one or both of the 3D model of the patient's upper dentition and the 3D model of the patient's lower dentition based on the model of the patient's anterior teeth; displaying a first occlusion map for the patient based on the adjusted model of the upper dentition in occlusion with the adjusted model of the lower dentition and a second occlusion map for the patient based on the model of the upper dentition in occlusion with the model of the lower dentition.

Clause 33. The method of clause 32, wherein the displaying includes displaying the first occlusion map simultaneously with the second occlusion map.

Clause 34. The method of clause 30, further comprising: receiving a selection of first occlusion map or the second occlusion map.

Clause 35. The method of clause 32, wherein the displaying includes displaying includes displaying the adjusted 3D model of the patient's upper dentition and the adjusted 3D model of the patient's lower dentition in occlusion with the first adjusted occlusion map.

Clause 36. The method of clause 32, further comprising: receiving a rejection of the adjusted occlusion map based; requesting a model of a first portion of a side of the patient's dental arches while the upper dentition is in occlusion with the patient's lower dentition, adjusting the shape of the one or both of the 3D model of the patient's upper dentition and the 3D model of the patient's lower dentition based on the model of the patient's anterior teeth and the model of the first portion of a side of the patient's dental arches, displaying the first occlusion map for the patient based on the adjusted model of the upper dentition in occlusion with the adjusted model of the lower dentition and a third occlusion map for the patient based on the model of the upper dentition in occlusion with the model of the lower dentition and the model of the first portion of a side of the patient's dental arches.

Clause 37. A system for generating an occlusion map of a patient's dentition, comprising: one or more processors and memory comprising instructions that when executed by one or more of the processors causes the system to carry out the method of any one of the preceding clauses.

Clause 38. An intraoral scanning system for generating an occlusion map of a patient's dentition, comprising: an intraoral scanner comprising a handheld wand and one or more processors and memory comprising instructions that when executed by one or more of the processors causes the system to carry out a method comprising: receiving stitched 3D scan data of a patient's upper jaw; receiving stitched 3D scan data of a patient's lower jaw; receiving a model of the patient's upper jaw in occlusion with the patient's lower jaw; adjusting a shape of the one or both of the stitched 3D scan data of the patient's upper jaw and the stitched 3D scan data of the patient's lower jaw based on the model of the model of the patient's upper jaw in occlusion with the patient's lower jaw; generating occlusion map for the patient based on the adjusted 3D scan data of the upper jaw in occlusion with the adjusted 3D scan data of the lower jaw.

Clause 39. The system of clause 38, wherein the stitched 3D scan data of a patient's upper jaw is a 3D model of the patient's upper jaw and the stitched 3D scan data of a patient's lower jaw is a 3D model of the patient's lower jaw.

Clause 40. The system of clause 38, wherein 3D model of the patient's upper jaw includes all of the teeth of the upper arch of the patient and the receiving a 3D model of the patient's lower jaw includes all of the teeth of the lower arch of the patient.

Clause 41. The system of clause 38, wherein the model of the patient's upper jaw in occlusion with the patient's lower jaw includes anterior teeth.

Clause 42. The system of clause 38, wherein 3D model of the patient's upper jaw includes fewer than all of the teeth of the upper arch of the patient and the receiving a 3D model of the patient's lower jaw includes fewer than all of the teeth of the lower arch of the patient.

Clause 43. The system of clause 38, wherein the 3D model of the patient's upper jaw and the 3D model of the patient's lower jaw are adjusted in width, length, or height.

Clause 44. The system of clause 38, wherein adjusting the 3D model of the patient's upper jaw and the 3D model of the patient's lower jaw are adjusted using a distortion function that adjusts one or more parameters of the 3D model of the patient's upper jaw or 3D model of the patient's lower jaw.

Clause 45. The system of clause 44, wherein the distortion function is constrained by one or more loss functions.

Clause 46. The system of clause 38, wherein adjusting the 3D model of the patient's upper jaw and adjusting the 3D model of the patient's lower jaw further comprises estimating an accuracy of the 3D model of the patient's upper jaw and an accuracy of the 3D model of the patient's lower jaw and adjusting the 3D model of the patient's upper jaw based on the accuracy of the 3D model of the patient's upper jaw and adjusting the 3D model of the patient's lower jaw based on the accuracy of the 3D model of the patient's lower jaw.

Clause 47. The system of clause 46, wherein adjusting the 3D model of the patient's upper jaw and adjusting the 3D model of the patient's lower jaw further comprises assigning weights of one or more parameters of 3D model of the patient's upper jaw based on the accuracy of the model of the upper jaw and assigning weights of one or more parameters of 3D model of the patient's lower jaw based on the accuracy of the model of the lower jaw.

Clause 48. The system of clause 46, wherein the estimated accuracies are based on an existence or size of an endentuous region in the 3D model of the patient's upper jaw or of the 3D model of the patient's lower jaw.

Clause 49. The system of clause 46, wherein the estimated accuracies is based on an overlap of scan data associated with the 3D model of the patient's upper jaw or of the 3D model of the patient's lower jaw.

Clause 50. The system of clause 46, wherein the estimated accuracies is based on amount of scan data associated with the 3D model of the patient's upper jaw or of the 3D model of the patient's lower jaw.

Clause 51. The system of clause 46, wherein the estimated accuracies is based on palatal region included within the scan the 3D model of the patient's upper jaw.

Clause 52. The system of clause 51, wherein adjusting the 3D model of the patient's upper jaw and adjusting the 3D model of the patient's lower jaw further comprises estimating a relative accuracy of the 3D model of the patient's upper jaw with respect to the 3D model of the patient's lower jaw and adjusting the 3D model of the patient's upper jaw and the 3D model of the patient's lower jaw based on the relative accuracy of the 3D model of the patient's upper jaw compared to the 3D model of the patient's lower jaw.

Clause 53. The system of clause 52, wherein adjusting the 3D model of the patient's upper jaw and adjusting the 3D model of the patient's lower jaw further comprises assigning weights of one or more parameters of 3D model of the patient's upper jaw based on the relative accuracy of 3D model of the patient's upper jaw compared to the 3D model of the patient's lower jaw.

Clause 54. The system of clause 52, wherein the relative accuracy is based on an existence or size of an endentuous region in the 3D model of the patient's upper jaw or of the 3D model of the patient's lower jaw.

Clause 55. The system of clause 52, wherein the relative accuracy is based on an overlap of scan data associated with the 3D model of the patient's upper jaw or of the 3D model of the patient's lower jaw.

Clause 56. The system of clause 52, wherein the relative accuracy is based on amount of scan data associated with the 3D model of the patient's upper jaw or of the 3D model of the patient's lower jaw.

Clause 57. The system of clause 15, wherein the relative accuracy is based on palatal region included within the scan the 3D model of the patient's upper jaw.

Clause 58. The system of clause 38, wherein the occlusion map is applied to a 3D model of the patient's dentition.

Clause 59. The system of clause 38, wherein model of the patient's upper jaw in occlusion includes lingual surfaces of the patient's upper and lower jaw.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. A system for correcting an intraoral scan, comprising:
an intraoral scanner comprising a handheld wand and one or more processors and memory comprising instructions that when executed by one or more of the processors causes the system to carry out a method comprising:
receiving stitched 3D scan data of a patient's upper jaw;
receiving stitched 3D scan data of a patient's lower jaw;
receiving a model of the patient's upper jaw in occlusion with the patient's lower jaw;
adjusting a shape of the one or both of the stitched 3D scan data of the patient's upper jaw and the stitched 3D scan data of the patient's lower jaw based on the model of the patient's upper jaw in occlusion with the patient's lower jaw to correct for accumulated errors in the stitched 3D scan data of the patient's upper jaw and the stitched 3D scan data of the patient's lower jaw.

2. The system of claim 1, wherein the stitched 3D scan data of a patient's upper jaw is a 3D model of the patient's upper jaw and the stitched 3D scan data of a patient's lower jaw is a 3D model of the patient's lower jaw.

3. The system of claim 2, wherein 3D model of the patient's upper jaw includes all teeth of the upper jaw of the patient and the receiving a 3D model of the patient's lower jaw includes all teeth of the lower jaw of the patient.

4. The system of claim 1, wherein the model of the patient's upper jaw in occlusion with the patient's lower jaw includes anterior teeth.

5. The system of claim 2, wherein 3D model of the patient's upper jaw includes fewer than all teeth of the upper jaw of the patient and the receiving a 3D model of the patient's lower jaw includes fewer than all teeth of the lower jaw of the patient.

6. The system of claim 2, wherein the 3D model of the patient's upper jaw and the 3D model of the patient's lower jaw are adjusted in width, length, or height.

7. The system of claim 2, wherein adjusting the 3D model of the patient's upper jaw and the 3D model of the patient's lower jaw are adjusted using a distortion function that adjusts one or more parameters of the 3D model of the patient's upper jaw or 3D model of the patient's lower jaw.

8. The system of claim 7, wherein the distortion function is constrained by one or more loss functions.

9. A system for correcting an intraoral scan, comprising:
an intraoral scanner comprising a handheld wand and one or more processors and memory comprising instructions that when executed by one or more of the processors causes the system to carry out a method comprising:
receiving stitched 3D scan data of a patient's upper jaw;
receiving stitched 3D scan data of a patient's lower jaw;
receiving a model of the patient's upper jaw in occlusion with the patient's lower jaw;
adjusting a shape of the one or both of the stitched 3D scan data of the patient's upper jaw and the stitched 3D scan data of the patient's lower jaw based on the model of the patient's upper jaw in occlusion with the patient's lower jaw;
output an occlusion map for the patient based on the adjusted 3D scan data for the upper jaw in occlusion with the adjusted 3D scan data of the lower jaw.

10. The system of claim 9, wherein adjusting the 3D scan data of the patient's upper jaw and adjusting the 3D scan data of the patient's lower jaw further comprises estimating an accuracy of the 3D scan data of the patient's upper jaw and an accuracy of the 3D scan data of the patient's lower jaw and adjusting the 3D scan data of the patient's upper jaw based on the accuracy of the 3D scan data of the patient's upper jaw and adjusting the 3D scan data of the patient's lower jaw based on the accuracy of the 3D scan data of the patient's lower jaw.

11. The system of claim 10, wherein adjusting the 3D scan data of the patient's upper jaw and adjusting the 3D scan data of the patient's lower jaw further comprises assigning weights of one or more parameters of the 3D scan data of the patient's upper jaw based on the accuracy of the 3D scan data of the patient's upper jaw and assigning weights of one or more parameters of 3D scan data of the patient's lower jaw based on the accuracy of the 3D scan data of the patient's lower jaw.

12. The system of claim 10, wherein estimating the accuracies are based on an existence or size of an endentuous region in the 3D scan data of the patient's upper jaw or of the 3D scan data of the patient's lower jaw.

13. The system of claim 10, wherein the estimating the accuracies is based on an overlap of scan data associated with the 3D scan data of the patient's upper jaw or of the 3D scan data of the patient's lower jaw.

14. The system of claim 10, wherein estimating the accuracies is based on amount of scan data associated with the 3D scan data of the patient's upper jaw or of the 3D scan data of the patient's lower jaw.

15. The system of claim 10, wherein estimating the accuracies is based on palatal region included within the scan the 3D scan data of the patient's upper jaw.

16. The system of claim 15, wherein adjusting the 3D scan data of the patient's upper jaw and adjusting the 3D scan data of the patient's lower jaw further comprises estimating a relative accuracy of the 3D scan data of the patient's upper jaw with respect to the 3D scan data of the patient's lower jaw and adjusting the 3D scan data of the patient's upper jaw and the 3D scan data of the patient's lower jaw based on the relative accuracy of the 3D scan data of the patient's upper jaw compared to the 3D scan data of the patient's lower jaw.

17. The system of claim 16, wherein adjusting the 3D scan data of the patient's upper jaw and adjusting the 3D scan data of the patient's lower jaw further comprises assigning weights of one or more parameters of 3D scan data of the patient's upper jaw based on the relative accuracy of 3D scan data of the patient's upper jaw compared to the 3D scan data of the patient's lower jaw.

18. A method of treating a patient's dentition, comprising:
receiving stitched 3D scan data of a patient's upper jaw;
receiving stitched 3D scan data of a patient's lower jaw;
receiving a model of the patient's upper jaw in occlusion with the patient's lower jaw;
adjusting a shape of the one or both of the stitched 3D scan data of the patient's upper jaw and the stitched 3D scan data of the patient's lower jaw based on the model of the patient's upper jaw in occlusion with the patient's lower jaw;
generating a 3D model of a restorative object based on the adjusted shape of one or both of the stitched 3D scan data of the patient's upper jaw and the stitched 3D scan data of the patient's lower jaw;
outputting the 3D model of the restorative object for fabrication of the restorative object.

19. The method of claim 18, further comprising generating an occlusion map for the patient based on the adjusted 3D scan data of the upper jaw in occlusion with the adjusted 3D scan data of the lower jaw, wherein the occlusion map is applied to a 3D model of the patient's dentition.

20. The method of claim 18, wherein model of the patient's upper jaw in occlusion includes lingual surfaces of the patient's upper and lower jaw.

21. The method of claim 18, wherein adjusting the 3D scan data of the patient's upper jaw and adjusting the 3D scan data of the patient's lower jaw further comprises estimating a relative accuracy of the 3D scan data of the patient's upper jaw with respect to the 3D scan data of the patient's lower jaw and adjusting the 3D scan data of the patient's upper jaw and the 3D scan data of the patient's lower jaw based on the relative accuracy of the 3D scan data of the patient's upper jaw compared to the 3D scan data of the patient's lower jaw.

22. The method of claim 21, wherein the relative accuracy is based on an existence or size of an endentuous region in the 3D scan data of the patient's upper jaw or of the 3D scan data of the patient's lower jaw.

23. The method of claim 21, wherein the relative accuracy is based on an overlap of scan data associated with the 3D scan data of the patient's upper jaw or of the 3D scan data of the patient's lower jaw.

24. The method of claim 21, wherein the relative accuracy is based on amount of scan data associated with the 3D scan data of the patient's upper jaw or of the 3D scan data of the patient's lower jaw.
